(19) United States
(12) Patent Application Publication
(10) Pub. No.: US 2024/0174229 A1
(43) Pub. Date: May 30, 2024

(54) SPEED CONTROL ASSISTANCE APPARATUS

(71) Applicant: ISUZU MOTORS LIMITED, Tokyo (JP)

(72) Inventor: Motoya SUZUKI, Fujisawa-shi, Kanagawa, (JP)

(21) Appl. No.: 18/551,028

(22) PCT Filed: Mar. 23, 2022
(86) PCT No.: PCT/JP2022/013400

§ 371 Date: Sep. 18, 2023

(30) Foreign Application Priority Data
Mar. 26, 2021 (JP) 2021-053285

(51) Int. Cl. B60W 30/14; B60W 30/045

(52) U.S. Cl. CPC B60W 30/143; B60W 30/045; B60W 2530/10

(57) ABSTRACT

A speed control assistance apparatus includes: an acquiring part that acquires a target acceleration/deceleration instruction indicating a target acceleration/deceleration of a vehicle; a detecting part that detects an acceleration/deceleration of the vehicle; a storage part that stores a reference model outputting a model acceleration/deceleration, which is the acceleration/deceleration of the vehicle when the target acceleration/deceleration was input; and a determining part that determines a corrected acceleration/deceleration, which is an acceleration/deceleration to be indicated to a speed control part controlling the speed of the vehicle at a second timing in a cycle subsequent to a cycle corresponding to the first timing, by adding a difference between the acceleration/deceleration detected by the detecting part at the first timing and the model acceleration/deceleration output by the reference model to which the target acceleration/deceleration instruction at the first timing is input, to an acceleration/deceleration corresponding to the target acceleration/deceleration instruction.

### TECHNICAL FIELD

The present disclosure relates to a speed control assistance apparatus.

### BACKGROUND OF THE INVENTION

Conventionally, a speed control apparatus for controlling the speed of a vehicle is known. Patent Document 1 discloses a vehicle control apparatus that determines an acceleration/deceleration and a steering angle suitable for a vehicle to travel by using a vehicle model.

### PRIOR ART

### Patent Document

Patent Document 1: Japanese Unexamined Patent Application Publication No. 2017-84110

### BRIEF DESCRIPTION OF THE INVENTION

### Problem to be Solved by the Invention

In the case of controlling a vehicle with an acceleration/deceleration that is determined using a vehicle model when the vehicle model does not match the state of the actual vehicle, an acceleration/deceleration of the vehicle deviates from a target value of the acceleration/deceleration.

The present disclosure has been made in view of these points, and its object is to improve the accuracy of controlling a vehicle when a model used for controlling the vehicle's traveling is different from the state of the actual vehicle.

### Means for Solving the Problem

A speed control assistance apparatus according to an aspect of the present disclosure includes: an acquiring part that acquires a target acceleration/deceleration instruction indicating a target acceleration/deceleration of a vehicle, in a constant cycle; a detecting part that detects an acceleration/deceleration of the vehicle, in the constant cycle; a storage part that stores a reference model outputting a model acceleration/deceleration, which is an acceleration/deceleration of the vehicle provided with the target acceleration/deceleration instruction at the first timing when the target acceleration/deceleration instruction at the first timing is input to the reference model; and a determining part that determines a corrected acceleration/deceleration, which is an acceleration/deceleration to be indicated to a speed control part controlling a speed of the vehicle at a second timing in a cycle subsequent to a cycle corresponding to the first timing, by adding a difference between the acceleration/deceleration detected by the detecting part at the first timing and the model acceleration/deceleration output by the reference model to which the target acceleration/deceleration instruction at the first timing is input, to an acceleration/deceleration corresponding to the target acceleration/deceleration instruction.

The storage part may store a plurality of the reference models, corresponding to a weight of the vehicle, that output the model acceleration/deceleration with a smaller absolute value as the weight of the vehicle becomes greater, the acquiring part may acquire the weight of the vehicle, and the determining part may select, from the plurality of reference models, one of the reference models corresponding to the weight of the vehicle, and may use the selected reference model to determine the corrected acceleration/deceleration.

The determining part may determine the corrected acceleration/deceleration such that a timing at which the speed of the vehicle reaches the target acceleration/deceleration is delayed as the weight of the vehicle becomes greater.

The storage part may store a plurality of the reference models, corresponding to a steering angle of the vehicle, that output the model acceleration/deceleration with a smaller absolute value as the steering angle of the vehicle becomes larger, the acquiring part may acquire the steering angle of the vehicle, and the determining part may select, from the plurality of reference models, one of the reference models corresponding to the steering angle of the vehicle, and may determine the corrected acceleration/deceleration using the selected reference model.

The determining part may determine the corrected acceleration/deceleration such that a timing at which the speed of the vehicle reaches the target acceleration/deceleration is delayed as the steering angle of the vehicle becomes larger.

The storage part may store a plurality of the reference models, corresponding to curvature of a road surface on which the vehicle travels, that output the model acceleration/deceleration with a smaller absolute value as the curvature of the road surface on which the vehicle travels becomes larger, the acquiring part may acquire the curvature of the road surface on which the vehicle travels, and the determining part may select, from the plurality of reference models, one of the reference models corresponding to the curvature of the road surface on which the vehicle travels, and may determine the corrected acceleration/deceleration using the selected reference model.

The determining part may determine the corrected acceleration/deceleration such that a timing at which the speed of the vehicle reaches the target acceleration/deceleration is delayed as the curvature of the road surface on which the vehicle travels becomes larger.

The speed control assistance apparatus may include: an operation receiving part that receives an operation of selecting whether to input the corrected acceleration/deceleration or to input the acceleration/deceleration corresponding to the target acceleration/deceleration instruction to the speed control part; and an output part that selects one of the corrected acceleration/deceleration or the acceleration/deceleration corresponding to the target acceleration/deceleration instruction, and outputs the selected acceleration/deceleration to the speed control part on the basis of the operation received by the operation receiving part.

### Effect of the Invention

According to the present disclosure, it is possible to improve the accuracy of controlling a vehicle when a model used for controlling the vehicle's traveling is different from the state of the actual vehicle.

### BRIEF DESCRIPTION OF THE DRAWINGS

FIG. 1 shows a configuration of a speed control assistance system S.

FIG. 2 shows a configuration of a determining part 123.

FIG. 3 is a graph showing a target acceleration/deceleration and an acceleration/deceleration of a vehicle.

FIG. 4 is a flowchart showing an example of the operation of the speed control assistance apparatus 10.

### DESCRIPTION OF EMBODIMENTS

### [Outline of the Speed Control Assistance System S]

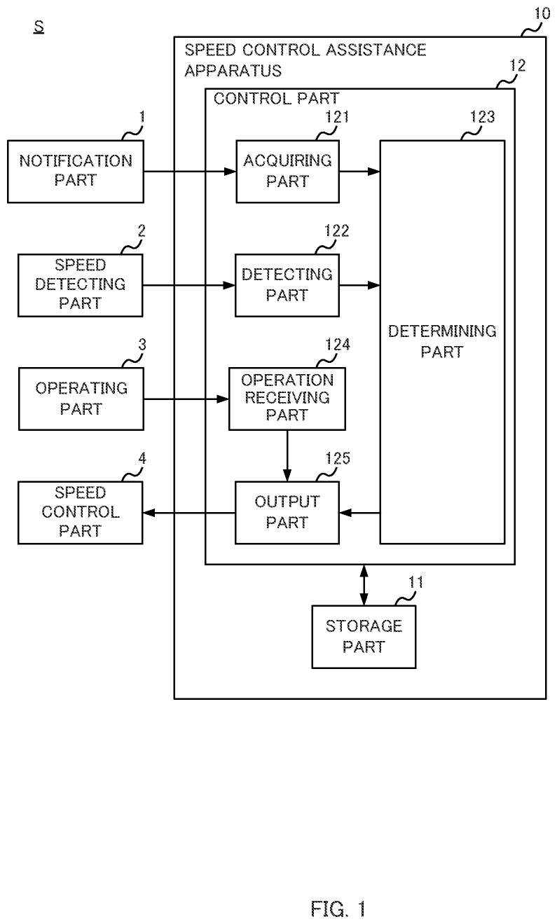

FIG. 1 shows a configuration of a speed control assistance system S. The speed control assistance system S includes a notification part 1, a speed detecting part 2, an operating part 3, a speed control part 4, and a speed control assistance apparatus 10. The speed control assistance system S is a system for improving the accuracy of controlling a vehicle's traveling by causing the vehicle to travel with acceleration/deceleration corresponding to a target acceleration/deceleration even though a model used for controlling the vehicle's traveling is different from the state of the actual vehicle. The target acceleration/deceleration is an acceleration/deceleration indicated by an Electronic Control Unit (ECU), for example.

The notification part 1 provides notification, in a constant cycle, about the speed control assistance apparatus 10 of a target acceleration/deceleration instruction indicating the target acceleration/deceleration of the vehicle, which is acquired from the ECU, the weight of the vehicle, a steering angle of the vehicle, and curvature of a road surface on which the vehicle travels, for example.

The speed detecting part 2 outputs the speed of the vehicle measured by a speed sensor (not shown) included in the vehicle, to the speed control assistance apparatus 10 in a constant cycle, for example.

The operating part 3 includes a button or a touch panel, for example. A driver of the vehicle presses the button or the touch panel of the operating part 3, thereby performing operations of causing the speed control assistance apparatus 10 to start or stop an operation of controlling the acceleration/deceleration of the vehicle. The operating part 3 notifies the speed control assistance apparatus 10 of the result of an operation made by the driver of the vehicle.

The speed control part 4 controls the acceleration/deceleration of the vehicle on the basis of the acceleration/deceleration output from the speed control assistance apparatus 10 in a constant cycle. The speed control part 4 includes a transfer function for identifying an indicated torque corresponding to the acceleration/deceleration instruction of the vehicle, which is produced on the basis of design data of the vehicle, for example.

The speed control assistance apparatus 10 has a reference model used for controlling the vehicle's traveling. The reference model is a transfer function generated on the basis of the design data of the vehicle, for example, and outputs a model acceleration/deceleration corresponding to the target acceleration/deceleration instruction. The model acceleration/deceleration is an acceleration/deceleration when the reference model and the state of the vehicle are the same. The speed control assistance apparatus 10 determines a corrected acceleration/deceleration on the basis of (i) the model acceleration/deceleration output from the reference model to which the target acceleration/deceleration instruction notified by the notification part was input and (ii) the speed of the vehicle output by the speed detecting part 2, and outputs the corrected acceleration/deceleration to the speed control part 4.

The speed control assistance apparatus 10 operating in this manner can output, to the speed control part 4, the corrected acceleration/deceleration for causing the vehicle to travel with the target acceleration/deceleration even though the reference model and the state of the actual vehicle are different from each other. As a result, the speed control assistance apparatus 10 can improve the accuracy of controlling the vehicle. Hereinafter, a configuration and the operation of the speed control assistance apparatus 10 will be described in detail.

### [Configuration of the Speed Control Assistance Apparatus 10]

The speed control assistance apparatus 10 includes a storage part 11 and a control part 12. The control part 12 includes an acquiring part 121, a detecting part 122, a determining part 123, an operation receiving part 124, and an output part 125.

The storage part 11 includes storage media such as a Read Only Memory (ROM), a Random Access Memory (RAM), and a Solid State Drive (SSD). The storage part 11 stores a program executed by the control part 12 and a plurality of reference models. The reference model is a program indicating a linear, time-invariant transfer function, for example. The details of the reference model will be described later.

The control part 12 is a Central Processing Unit (CPU), for example. The control part 12 operates as the acquiring part 121, the detecting part 122, the determining part 123, the operation receiving part 124, and the output part 125 by executing a program stored in the storage part 11.

The acquiring part 121 acquires the target acceleration/deceleration instruction indicating the target acceleration/deceleration of the vehicle from the notification part 1 in a constant cycle. The acquiring part 121 may acquire the weight of the vehicle, a steering angle of the vehicle, and curvature of a road surface on which the vehicle travels, from the notification part 1 in a constant cycle.

The detecting part 122 detects the acceleration/deceleration of the vehicle in a constant cycle. The detecting part 122 detects the acceleration/deceleration of the vehicle in a constant cycle on the basis of the speed of the vehicle output by the speed detecting part 2 in a constant cycle. A cycle in which the speed detecting part 2 outputs the speed of the vehicle, and a cycle in which the detecting part 122 detects the acceleration/deceleration may be the same, or may be different from each other.

The determining part 123 determines the corrected acceleration/deceleration on the basis of the target acceleration/deceleration instruction acquired by the acquiring part 121, the acceleration/deceleration detected by the detecting part 122, and the reference model stored in the storage part 11. When the target acceleration/deceleration instruction at a first timing is input, the reference model outputs the model acceleration/deceleration, which is an acceleration/deceleration of the vehicle provided with the target acceleration/deceleration instruction at the first timing. Although the model acceleration/deceleration is an acceleration/deceleration corresponding to the target acceleration/deceleration instruction at the first timing, if the reference model does not match the state of the actual vehicle, which changes over time, for example, the model acceleration/deceleration may not be an acceleration/deceleration suitable for the target acceleration/deceleration instruction.

The determining part 123 determines a corrected acceleration/deceleration at a second timing in a cycle subsequent to a cycle corresponding to the first timing on the basis of the acceleration/deceleration of the vehicle at the first timing and the target acceleration/deceleration instruction. The determining part 123 adds the difference between the acceleration/deceleration detected by the detecting part 122 at the first timing and the model acceleration/deceleration output by the reference model to which the target acceleration/deceleration instruction at the first timing was input, to the acceleration/deceleration corresponding to the target acceleration/deceleration instruction. Then, the determining part 123 determines the corrected acceleration/deceleration, which is an acceleration/deceleration to be indicated to the speed control part 4 that controls the speed of the vehicle at the second timing in a cycle subsequent to the cycle corresponding to the first timing. The determining part 123 operating in this manner can output, to the speed control part 4, the corrected acceleration/deceleration for the vehicle to travel with the acceleration/deceleration corresponding to the target acceleration/deceleration instruction even though the reference model and the state of the actual vehicle are different from each other.

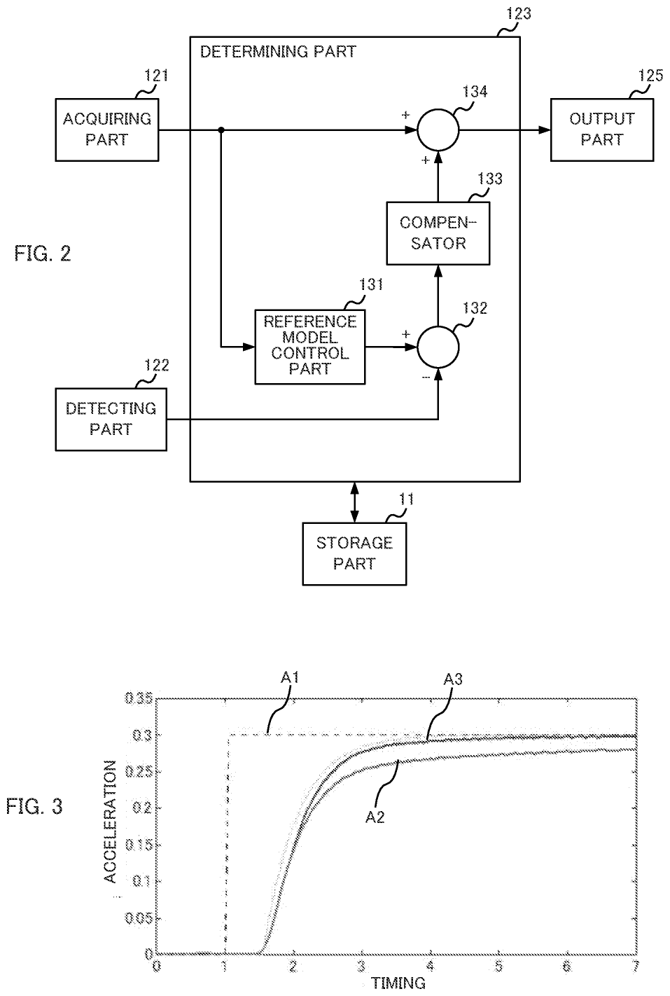

Hereinafter, a configuration and operation of the determining part 123 will be described in detail using FIG. 2. FIG. 2 shows the configuration of the determining part 123. The determining part 123 includes a reference model control part 131, a subtractor 132, a compensator 133, and an adder 134.

The reference model control part 131 identifies the model acceleration/deceleration corresponding to the target acceleration/deceleration instruction by inputting, to the reference model acquired from the storage part 11, the target acceleration/deceleration corresponding to the target acceleration/deceleration instruction acquired by the acquiring part 121 at the first timing. The reference model control part 131 outputs the identified model acceleration/deceleration to the subtracter 132.

The subtracter 132 outputs, to the compensator 133, the difference between the model acceleration/deceleration output by the reference model control part 131 at the first timing and the acceleration/deceleration of the vehicle detected by the detecting part 122 at the first timing.

The compensator 133 is a linear, time-invariant transfer function using a Proportional Differential (PD) control or an H-infinity (H∞) control, for example. In order to improve the accuracy of the corrected acceleration/deceleration at the second timing, the compensator 133 compensates for the difference between the model acceleration/deceleration output by the subtractor 132 at the first timing and the acceleration/deceleration of the vehicle. The compensator 133 outputs, to the adder 134, a compensation value obtained by compensating for the difference between the model acceleration/deceleration and the acceleration/deceleration of the vehicle.

The adder 134 generates the corrected acceleration/deceleration at the second timing by adding the target acceleration/deceleration corresponding to the target acceleration/deceleration instruction acquired by the acquiring part 121 at the first timing and the compensation value output by the compensator 133 at the first timing. The adder 134 outputs the corrected acceleration/deceleration at the second timing to the output part 125.

A corrected acceleration/deceleration R at the second timing can be expressed by the following equation (1) by using a target acceleration/deceleration r at the first timing, an acceleration/deceleration y of the vehicle at the first timing, a reference model Td(s) used by the reference model control part 131, and a transfer function D(s) used by the compensator 133.

[Equation 1]

R=r+D(s)(T_{d}(s)r−y) (1)

FIG. 3 is a graph showing the target acceleration/deceleration and the acceleration/deceleration of the vehicle. The horizontal axis of FIG. 3 represents a timing, and the vertical axis of FIG. 3 represents an acceleration. An acceleration A1 is a target acceleration/deceleration corresponding to the target acceleration/deceleration instruction. An acceleration A2 is an acceleration/deceleration of the vehicle when the speed control part 4 acquires the target acceleration/deceleration. An acceleration A3 is an acceleration/deceleration of the vehicle when the speed control part 4 acquires the corrected acceleration/deceleration.

As shown in FIG. 3, at a timing 7, the acceleration/deceleration (acceleration A3) of the vehicle corresponding to the corrected acceleration/deceleration is closer to the target acceleration/deceleration (acceleration A1) than the acceleration/deceleration (acceleration A2) of the vehicle corresponding to the target acceleration/deceleration.

As described above, the determining part 123 outputs, to the speed control part 4, the corrected acceleration/deceleration obtained by correcting the target acceleration/deceleration corresponding to the target acceleration/deceleration instruction. As a result, even when the target acceleration/deceleration and the acceleration/deceleration of the vehicle traveling on the basis of this target acceleration/deceleration are different from each other due to the reference model being different from the state of the actual vehicle, for example, the determining part 123 can cause the vehicle to travel with the corrected acceleration/deceleration corresponding to the target acceleration/deceleration.

Specifically, even when an internal combustion engine or a motor of the vehicle deteriorates over time, the determining part 123 determines the corrected acceleration/deceleration for the vehicle to travel with the target acceleration/deceleration by detecting the output characteristics (speed of the vehicle) of the deteriorated internal combustion engine or motor with the detecting part 122. As a result, the determining part 123 can improve the accuracy of controlling the vehicle.

Further, by updating the reference model stored in the storage part 11 without changing the transfer function included in the speed control part 4, the determining part 123 can change the indicated torque output by the speed control part 4. As a result, the speed control assistance apparatus 10 can easily change control of the acceleration/deceleration of the vehicle.

The determining part 123 may select one of a plurality of reference models stored in the storage part 11, and may use the selected reference model to determine the corrected acceleration/deceleration. The storage part 11 stores a plurality of reference models, corresponding to the weight of the vehicle, for example, that output a model acceleration/deceleration with a smaller absolute value as the weight of the vehicle is greater. Then, the determining part 123 selects, from the plurality of reference models, one reference model corresponding to the weight of the vehicle acquired by the acquiring part 121, and determines the corrected acceleration/deceleration using the selected reference model.

The greater the weight of the vehicle, the more difficult it is to increase the acceleration/deceleration of the vehicle. Due to this, the determining part 123 uses the reference model corresponding to the weight of the vehicle to determine the corrected acceleration/deceleration corresponding to the weight of the vehicle. Specifically, the determining part 123 determines the corrected acceleration/deceleration such that a timing at which the speed of the vehicle reaches the target acceleration/deceleration corresponding to the target acceleration/deceleration instruction is delayed as the weight of the vehicle becomes greater. The determining part 123 operating in this manner can improve safety in changing the speed of the vehicle.

The determining part 123 may use a reference model corresponding to a steering angle of the vehicle acquired by the acquiring part 121 to determine the corrected acceleration/deceleration. In this case, the storage part 11 stores a plurality of reference models, corresponding to the steering angle of the vehicle, for example, that output a model acceleration/deceleration with a smaller absolute value as the steering angle of the vehicle becomes larger. Then, the determining part 123 selects one reference model corresponding to the steering angle of the vehicle from the plurality of reference models, and determines the corrected acceleration/deceleration using the selected reference model.

The larger the steering angle, the lower the safety of the vehicle with increased acceleration/deceleration. Due to this, the determining part 123 uses the reference model corresponding to the steering angle of the vehicle to determine the corrected acceleration/deceleration corresponding to the steering angle of the vehicle. Specifically, the determining part 123 determines the corrected acceleration/deceleration such that a timing at which the speed of the vehicle reaches the target acceleration/deceleration is delayed as the steering angle of the vehicle becomes larger. The determining part 123 operating in this manner can improve safety in changing the speed of the vehicle even when the steering angle of the vehicle is large.

The determining part 123 may determine the corrected acceleration/deceleration by using a reference model corresponding to curvature of a road surface on which the vehicle travels, which is acquired by the acquiring part 121. In this case, the storage part 11 stores a plurality of reference models, corresponding to the curvature of the road surface on which the vehicle travels, for example, that output a model acceleration/deceleration with a smaller absolute value as the curvature of the road surface on which the vehicle travels becomes larger. Then, the determining part 123 selects, from the plurality of reference models, one reference model corresponding to the curvature of the road surface on which the vehicle travels, and determines the corrected acceleration/deceleration using the selected reference model.

The larger the curvature of the road surface on which the vehicle travels, the lower the safety of the vehicle with increased acceleration/deceleration. Due to this, the determining part 123 determines the corrected acceleration/deceleration according to the steering angle of the vehicle by using the reference model corresponding to the curvature of the road surface on which the vehicle travels. Specifically, the determining part 123 determines the corrected acceleration/deceleration such that a timing at which the speed of the vehicle reaches the target acceleration/deceleration is delayed as the curvature of the road surface on which the vehicle travels becomes larger. The determining part 123 operating in this manner can improve safety in changing the speed of the vehicle even when the curvature of the road surface on which the vehicle travels is large.

The operation receiving part 124 receives the result of an operation made by the driver of the vehicle, which is output by the operating part 3. The operation receiving part 124 receives, from the operating part 3, an operation of selecting whether to input the corrected acceleration/deceleration to the speed control part 4 or to input the acceleration/deceleration corresponding to the target acceleration/deceleration instruction to the speed control part 4. When the driver operates the operating part 3 so as to control the acceleration/deceleration of the vehicle, the operation receiving part 124 receives, from the operating part 3, an operation of inputting the corrected acceleration/deceleration to the speed control part 4. When the driver operates the operating part 3 so as not to control the acceleration/deceleration of the vehicle, the operation receiving part 124 receives, from the operating part 3, an operation of inputting the target acceleration/deceleration to the speed control part 4.

The output part 125 selects one of the corrected acceleration/deceleration or the acceleration/deceleration corresponding to the target acceleration/deceleration instruction, on the basis of the operation received by the operation receiving part 124, and outputs the selected acceleration/deceleration to the speed control part 4. The output part 125 outputs the corrected acceleration/deceleration to the speed control part 4 when the driver operates so as to control the acceleration/deceleration of the vehicle, and the output part 125 outputs the target acceleration/deceleration to the speed control part 4 when the driver operates so as not to control the acceleration/deceleration of the vehicle. The output part 125 operating in this manner enables the driver to select whether or not to cause the vehicle to travel with the corrected acceleration/deceleration, depending on the driver's preference.

### [Flow Chart of the Speed Control Assistance Apparatus 10]

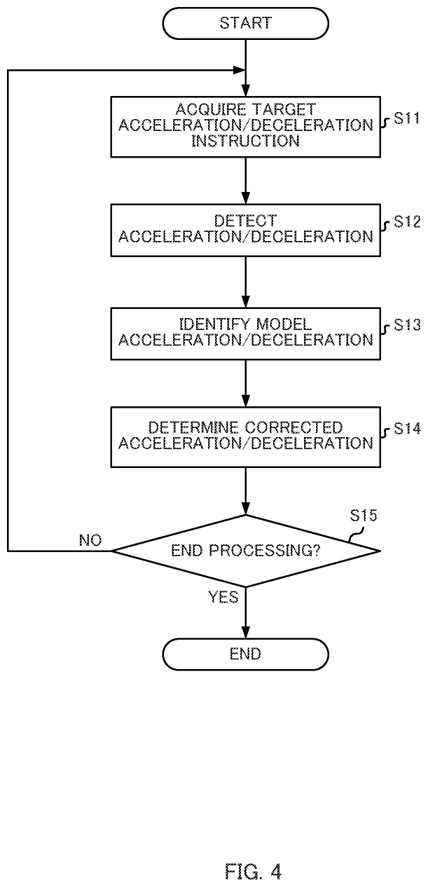

FIG. 4 is a flowchart showing an example of the operation of the speed control assistance apparatus 10. The flowchart shown in FIG. 4 shows an operation of the speed control assistance apparatus 10 to determine the corrected acceleration/deceleration on the basis of the target acceleration/deceleration.

The acquiring part 121 acquires the target acceleration/deceleration instruction at the first timing from the notification part (S11). The detecting part 122 detects the acceleration/deceleration of the vehicle at the first timing on the basis of the speed of the vehicle detected by the speed detecting part 2 (S12).

The determining part 123 identifies the model acceleration/deceleration at the first timing by inputting, to the reference model, the target acceleration/deceleration corresponding to the target acceleration/deceleration instruction at the first timing acquired by the acquiring part (S13). On the basis of the model acceleration/deceleration, the acceleration/deceleration of the vehicle, and the target acceleration/deceleration instruction at the first timing, the determining part 123 determines the corrected acceleration/deceleration at the second timing, which is a timing in a cycle subsequent to the first timing (S14).

If an operation of ending the processing has not been performed (“NO” in S15), the speed control assistance apparatus 10 repeats the processing from S11 to S14. If the operation of ending the processing is performed (“YES” in S15), the speed control assistance apparatus 10 ends the processing.

### [Effects of the Speed Control Assistance Apparatus 10]

As described above, the speed control assistance apparatus 10 includes the acquiring part 121 that acquires a target acceleration/deceleration instruction indicating a target acceleration/deceleration of the vehicle in a constant cycle, and the detecting part 122 that detects an acceleration/deceleration of the vehicle in a constant cycle. Then, the determining part 123 identifies a model acceleration/deceleration by inputting the target acceleration/deceleration instruction to the reference model stored in the storage part 11, and determines a corrected acceleration/deceleration on the basis of the identified model acceleration/deceleration and the acceleration/deceleration of the vehicle detected by the detecting part 122.

The speed control assistance apparatus 10 operating in this manner can cause the vehicle to travel with the target acceleration/deceleration even though a model used for controlling the vehicle's traveling is different from the state of the actual vehicle. This feature of the speed control assistance apparatus 10 is suitable when an internal combustion engine or a motor of the vehicle deteriorates over time, or when it is desired to correct the output characteristics of the internal combustion engine or the motor of the vehicle easily, for example.

The present disclosure is explained on the basis of the exemplary embodiments. The technical scope of the present disclosure is not limited to the scope explained in the above embodiments and it is possible to make various changes and modifications within the scope of the invention. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

### DESCRIPTION OF REFERENCE NUMERALS

1 notification part
2 speed detecting part
3 operating part
4 speed control part
10 speed control assistance apparatus
11 storage part
12 control part
121 acquiring part
122 detecting part
123 determining part
124 operation receiving part
125 output part
131 reference model control part
132 subtracter
133 compensator
134 adder

1. A speed control assistance apparatus comprising:
an acquiring part that acquires a target acceleration/deceleration instruction indicating a target acceleration/deceleration of a vehicle, in a constant cycle;
a detecting part that detects an acceleration/deceleration of the vehicle, in the constant cycle;
a storage part that stores a reference model outputting a model acceleration/deceleration, which is an acceleration/deceleration of the vehicle provided with the target acceleration/deceleration instruction at the first timing when the target acceleration/deceleration instruction at the first timing is input to the reference model; and
a determining part that determines a corrected acceleration/deceleration, which is an acceleration/deceleration to be indicated to a speed control part controlling a speed of the vehicle at a second timing in a cycle subsequent to a cycle corresponding to the first timing, by adding a difference between the acceleration/deceleration detected by the detecting part at the first timing and the model acceleration/deceleration output by the reference model to which the target acceleration/deceleration instruction at the first timing is input, to an acceleration/deceleration corresponding to the target acceleration/deceleration instruction.

2. The speed control assistance apparatus according to claim 1, wherein
the storage part stores a plurality of the reference models, corresponding to a weight of the vehicle, that output the model acceleration/deceleration with a smaller absolute value as the weight of the vehicle becomes greater,
the acquiring part acquires the weight of the vehicle, and
the determining part selects, from the plurality of reference models, one of the reference models corresponding to the weight of the vehicle, and uses the selected reference model to determine the corrected acceleration/deceleration.

3. The speed control assistance apparatus according to claim 2, wherein
the determining part determines the corrected acceleration/deceleration such that a timing at which the speed of the vehicle reaches the target acceleration/deceleration is delayed as the weight of the vehicle becomes greater.

4. The speed control assistance apparatus according to claim 1, wherein
the storage part stores a plurality of the reference models, corresponding to a steering angle of the vehicle, that output the model acceleration/deceleration with a smaller absolute value as the steering angle of the vehicle becomes larger,
the acquiring part acquires the steering angle of the vehicle, and
the determining part selects, from the plurality of reference models, one of the reference models corresponding to the steering angle of the vehicle, and determines the corrected acceleration/deceleration using the selected reference model.

5. The speed control assistance apparatus according to claim 4, wherein
the determining part determines the corrected acceleration/deceleration such that a timing at which the speed of the vehicle reaches the target acceleration/deceleration is delayed as the steering angle of the vehicle becomes larger.

6. The speed control assistance apparatus according to claim 1, wherein
the storage part stores a plurality of the reference models, corresponding to curvature of a road surface on which the vehicle travels, that output the model acceleration/deceleration with a smaller absolute value as the curvature of the road surface on which the vehicle travels becomes larger,
the acquiring part acquires the curvature of the road surface on which the vehicle travels, and
the determining part selects, from the plurality of reference models, one of the reference models corresponding to the curvature of the road surface on which the vehicle travels, and determines the corrected acceleration/deceleration using the selected reference model.

7. The speed control assistance apparatus according to claim 6, wherein
the determining part determines the corrected acceleration/deceleration such that a timing at which the speed of the vehicle reaches the target acceleration/deceleration is delayed as the curvature of the road surface on which the vehicle travels becomes larger.

8. The speed control assistance apparatus according to claim 1, further comprising:
an operation receiving part that receives an operation of selecting whether to input the corrected acceleration/deceleration or to input the acceleration/deceleration corresponding to the target acceleration/deceleration instruction to the speed control part; and
an output part that selects one of the corrected acceleration/deceleration or the acceleration/deceleration corresponding to the target acceleration/deceleration instruction, and outputs the selected acceleration/deceleration to the speed control part on the basis of the operation received by the operation receiving part.

9. The speed control assistance apparatus according to claim 8, wherein
the output part outputs the corrected acceleration/deceleration to the speed control part when a driver operates so as to control the acceleration/deceleration of the vehicle, and the output part outputs a target acceleration/deceleration corresponding to the target acceleration/deceleration instruction to the speed control part when the driver operates so as not to control the acceleration/deceleration of the vehicle.

10. The speed control assistance apparatus according to claim 1, wherein
the determining part includes:
a reference model control part that identifies a model acceleration/deceleration corresponding to the target acceleration/deceleration instruction by inputting, to the reference model acquired from the storage part, a target acceleration/deceleration corresponding to the target acceleration/deceleration instruction acquired by the acquiring part at the first timing;
a subtracter that outputs a difference between the model acceleration/deceleration output by the reference model control part at the first timing and the acceleration/deceleration of the vehicle detected by the detecting part at the first timing;
a compensator that outputs a compensation value obtained by compensating for a difference between the model acceleration/deceleration and the acceleration/deceleration output by the subtractor at the first timing, using a linear, time-invariant transfer function; and
an adder that generates a corrected acceleration/deceleration at the second timing by adding the target acceleration/deceleration corresponding to the target acceleration/deceleration instruction acquired by the acquiring part at the first timing to the compensation value output by the compensator at the first timing.
